(19) United States
(12) Patent Application Publication
(10) Pub. No.: US 2001/0047321 A1
(43) Pub. Date: Nov. 29, 2001

(54) Methods and systems for auctioning products

(76) Inventor: Gregory R. Wyatt, Avon, CT (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,722

(22) Filed: May 25, 2001

Related U.S. Application Data
(60) Provisional application No. 60/207,555, filed on May 25, 2000.

(51) Int. Cl. G06F 17/60

(52) U.S. Cl. 705/37

(57) ABSTRACT

A method for facilitating the auctioning of a pricing model using a network-based system comprises the step of receiving product listing and pricing information data from multiple suppliers. The system includes a server and at least one device connected to the server via a network. The method further comprises developing an initial regression equation for each supplier based on received product listing and price information data and combining the initial regression equations for each of the suppliers into a final regression equation for a product line.

### CROSS REFERENCE TO RELATED APPLICATIONS

This application claims the benefit of U.S. Provisional Application No. 60/207,555, filed May 25, 2000 which is hereby incorporated in it's entirety.

### BACKGROUND OF INVENTION

This invention relates generally to computer network-based auctions and more particularly to a network-based method for auctioning purchase contracts based on actual costs of a product.

In the course of a business, such as a manufacturing business, a large amount of engineered products are purchased. Since every engineered product is at least slightly different from previously purchased products, accurately assigning a cost to the engineered product is difficult. Furthermore the slight differences between the engineered products often prevent businesses from forming purchase contracts that are both accurate and which encompass a majority of the various engineered products.

In known systems the most effective way to form purchasing contracts for engineered products was to form a matrix agreement where the most commonly-specified aspects of the product are quoted for the entire product line which may include multiple sizes or ratings as the specified aspects. The resulting matrix often has several thousand entries. Disadvantages to this approach are that much time is spent pricing and negotiating each item, errors are common due to the size and complexity of the matrix and to limit matrix size, only a sampling of available products are included in the pricing matrix.

### SUMMARY OF INVENTION

In one aspect of the invention, a method is provided for facilitating the auctioning of a pricing model using a network-based system. The system includes a server and at least one device connected to the server via a network. The method comprises the steps of receiving product listing and pricing information data from multiple suppliers, developing an initial regression equation for each supplier based on received product listing and price information data, and combining the initial regression equations for each of the suppliers into a final regression equation for a product line.

In another aspect of the invention, a system is provided for facilitating the auctioning of purchase contracts for engineered products by implementing pricing models. The system comprises at least one device, a server and a network connecting the devices to the server. The server is configured to receive product listing and pricing information data from multiple suppliers, develop an initial regression equation for each supplier based on received product listing and price information data, and combine the initial regression equations for each supplier into a final regression equation for a product line.

In a further aspect of the invention, a computer is programmed to prompt a user to enter product listing and pricing information data from multiple suppliers, develop an initial regression equation for each supplier based on the received product listing and price information data, combine the initial regression equations for each of the suppliers into a final regression equation for a product line, transmit to the suppliers the final regression equation and a list of required products, and receive purchase contract bids from suppliers.

In another aspect of the invention, apparatus is provided which comprises means for receiving product listing and pricing information from multiple suppliers, means for developing an initial regression equation for each supplier based on the received product listing and price information, means for combining the initial regression equations for each of the suppliers into a combined regression equation for a product line, and means for receiving purchase contract bids from suppliers.

### BRIEF DESCRIPTION OF DRAWINGS

FIG. 1 is a system block diagram.

FIG. 2 is an expanded version block diagram of an exemplary embodiment of a server architecture of a system for implementing the network-based application for project management.

FIG. 3 is a flow diagram of a network-based method for auctioning purchase contracts for engineered products.

FIG. 4 is a supplier's abbreviated product list.

FIG. 5 is an exemplary pricing worksheet.

FIG. 6 is a user interface showing a bid sheet.

### DETAILED DESCRIPTION

Exemplary embodiments of systems and methods that facilitate a network-based method for auctioning products are described below in detail. The systems and methods facilitate, for example, auctioning purchase contracts based on actual costs of an engineered product.

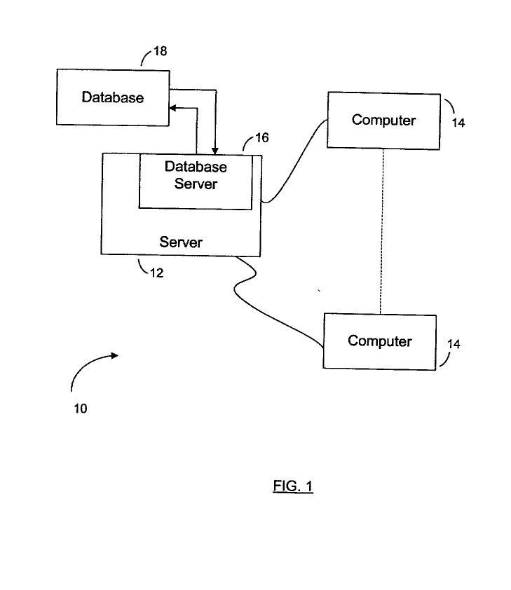

FIG. 1 is a block diagram of a system 10 in accordance with one embodiment of the present invention. System 10 includes a server sub-system 12, sometimes referred to herein as server 12, and a plurality of user devices 14 connected to server 12. In one embodiment, devices 14 are computers including a network browser, and server 12 is accessible to devices 14 via a network such as an intranet or the Internet. In an alternative embodiment, devices 14 are servers for a network of customer devices.

Devices 14 are interconnected to the network, such as a local area network (LAN) or a wide area network (WAN), through many interfaces including dial-in-connections, cable modems, DSL connections and high-speed ISDN lines. Alternatively, devices 14 are any devices capable of interconnecting to a network including a network-based phone or other network-based connectable equipment. Server 12 includes a database server 16 connected to a centralized database 18 containing project management information. In one embodiment, centralized database 18 is stored on database server 16 and can be accessed by potential users at one of user devices 14 by logging onto server sub-system 12 through one of user devices 14. In an alternative embodiment centralized database 18 is stored remotely from server 12.

More specifically, in an exemplary embodiment, the network-based method is implemented with an internal computer network including at least one server 12 coupled to remote terminals to form a local network such as, for example, an Intranet. In one embodiment, the Intranet is connected to a globally distributed computer network such as the Internet, including that part of the Internet known as the World Wide Web. Remote users access elements of system 10 from a remote terminal using an Internet connection and a network-browser. The network-browser is, for example, Netscape® by Netscape Communications Corporation, or Internet Explorer® by Microsoft Corporation, and is downloaded onto a user's remote terminal.

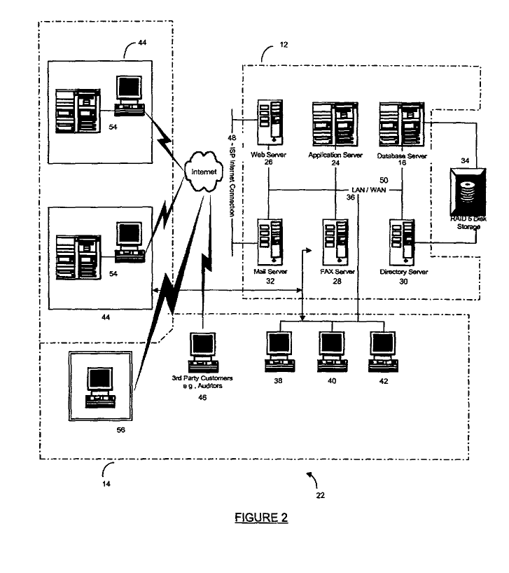

FIG. 2 is an expanded version block diagram of an exemplary embodiment of a server architecture of a system 22 including server sub-system 12 and user devices 14. Server sub-system 12 includes database server 16, an application server 24, a network server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator workstation 38, a user workstation 40, and a supervisor workstation 42 are coupled to LAN 36. Alternatively, workstations 38, 40, and 42 are coupled to LAN 36 via an Internet link or are connected through an intranet.

Each workstation 38, 40, and 42 is a personal computer having a network browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server sub-system 12 is configured to be communicatively coupled to various individuals or employees 44 and to third parties, e.g., users 46, via an ISP Internet connection 48. The communication in an exemplary embodiment is illustrated as being performed via the Internet, however, any other wide area network (WAN) type communication can be used in other embodiments, i.e., the systems and processes are not limited to being practiced via the Internet. In addition, and rather than a WAN 50, local area network 36 could be used in place of WAN 50.

In an exemplary embodiment, any employee 44 or user 46 having a workstation 52 can access server sub-system 12. One of user devices 14 includes a workstation 54 located at a remote location. Workstations 52 and 54 are personal computers having a network browser. Also, workstations 52 and 54 are configured to communicate with server sub-system 12. Furthermore, fax server 28 communicates with employees 44 and users 46 located outside the business entity and any of the remotely located user systems, including a user system 56 via a telephone link. Fax server 28 is configured to communicate with other workstations 38, 40, and 42 as well.

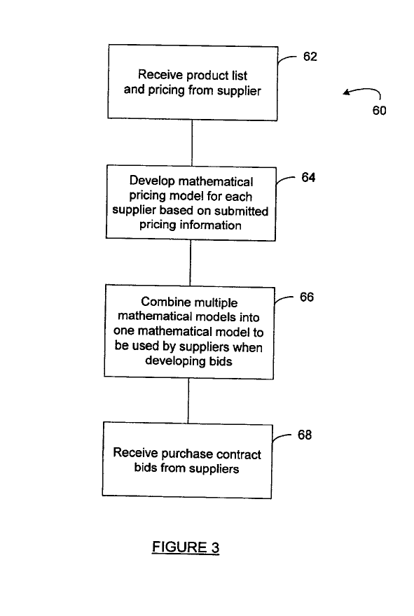

FIG. 3 is a flow diagram 60 for a network-based method of auctioning purchase contracts for engineered products. In an exemplary embodiment, the method is a web-based method and the specific products are transformers. The method includes the steps of receiving 62 product list information and pricing data from potential suppliers, developing 64 a regression equation or mathematical model for each supplier based on received product list information and pricing data, e.g., prices on product options, combining 66 the multiple mathematical models from the individual suppliers into one mathematical model to be used by all suppliers when configuring the purchase contract bids, and receiving 68 bids on purchase contracts from suppliers. In an alternative embodiment, the method includes receiving product list information and pricing data from a single supplier and using known electrical, physical, and manufacturing parameters to formulate an equation and then combining market-level pricing knowledge to form a mathematical model.

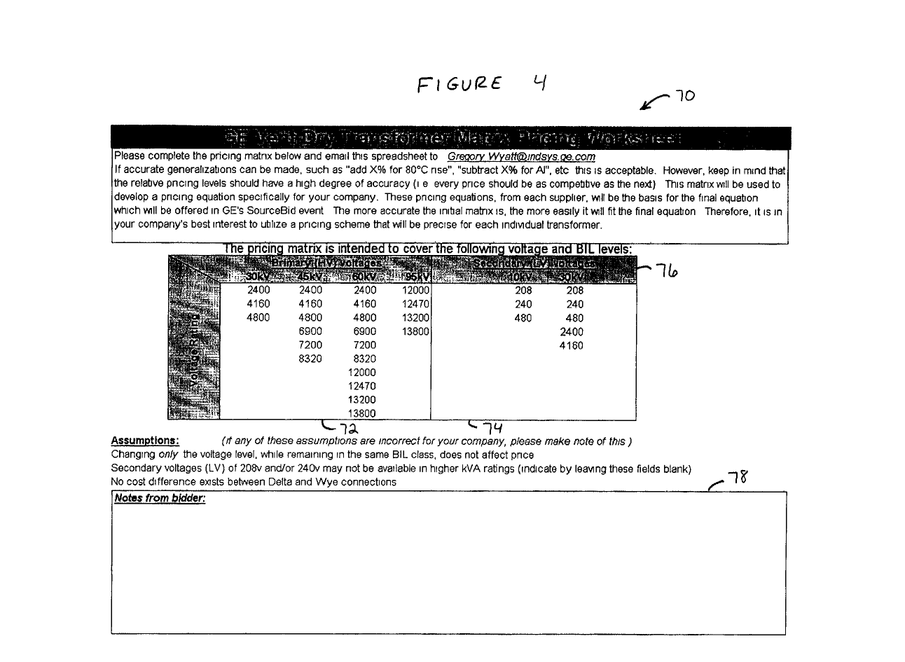

FIG. 4 illustrates one embodiment of a desired product list 70, accessible by a group of potential suppliers. List 70 is in the form of an abbreviated pricing matrix and in this example a transformer product line is to be priced by a supplier. The specific items listed are at least some of those items that affect pricing. List 70 is stored in database 18 (shown in FIG. 1) on server 12 (shown in FIG. 1) and is accessed by suppliers via computer system 10 (shown in FIG. 1). In one embodiment, list 70 is transmitted to a potential supplier by email. In an alternative embodiment, list 70 is transmitted to a potential supplier via a web-based information transfer process as is well known in the art. List 70 includes a primary voltage group 72 and a secondary voltage group 74. As part of list 70, primary voltage group 72 and secondary voltage group 74 are divided according to a total transformer voltage rating 76. List 70 provides a notes section 78 which allows a supplier to provide caveats to the supplied pricing information, for example add a percentage to the transformer prices for temperature rating or subtract a percentage for aluminum versus copper windings in the transformers.

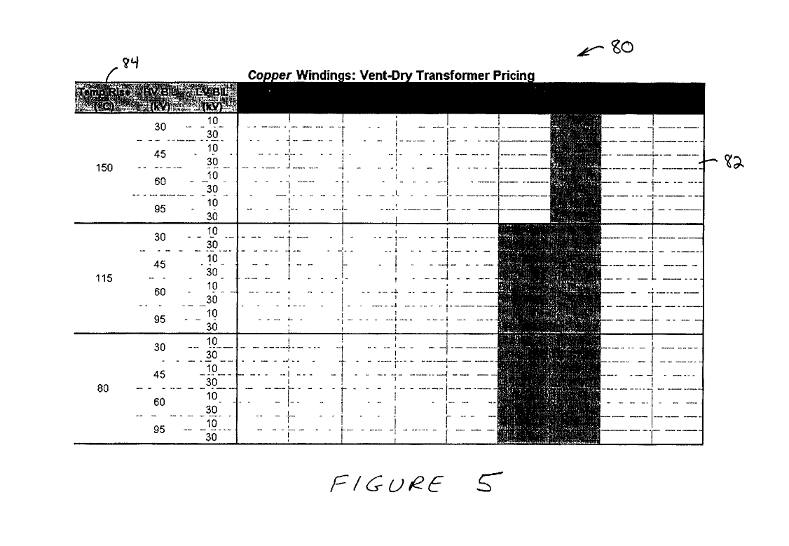

FIG. 5 shows an exemplary spreadsheet 80 stored in database 18 (shown in FIG. 1) on server 12 (shown in FIG. 1). Spreadsheet 80 provides data entry fields 82 into which a potential supplier enters pricing information. Spreadsheet 80 also is in matrix form and is delineated using ratings and groupings from list 70 (shown in FIG. 4). Spreadsheet 80 may also incorporate other well known parameters, such as, with respect to the transformer example, delineating a grouping 84 for temperature ratings of the priced transformers. Alternatively, multiple spreadsheets 80 are used to enter pricing information. Again using the transformer example, spreadsheet 80 is a spreadsheet that indicates to the supplier that copper windings are to be used in transformer pricing. Alternatively, spreadsheet 80 includes pricing matrices for both copper and aluminum windings.

Once pricing entries have been entered into spreadsheet 80, the supplier uploads the spreadsheet data to server 12 which stores the data in database 18. Alternatively, the spreadsheet data is received via email and is then loaded onto server 12 and stored in database 18. Server 12 accesses the pricing information from a supplier and generates an initial regression equation for each supplier's product line. Once the initial regression equations have been generated for each of the multiple potential suppliers, server 12 is further configured to combine the initial regression equations into a final regression equation. The final regression equation is then used by the purchaser of the engineered product to request bids from the multiple suppliers. In the transformer example, one exemplary final regression equation for bidding on transformers is

COST=847+26.7HVBIL−262LVBIL+16.3kVA+9.02(LVBIL)×(HVBIL) −0.0635(LVBIL)×(HVBIL)²+0.143(TEMP²×kVA²)/1,000,000 −0.0481(TEMP×kVA)−0.000025(TEMP×kVA²)

where HV is high voltage, LV is low voltage, BIL is basic impulse level, kVA is kiloVolt-Amperes, and TEMP is temperature rise. For other products, different final regression equations exist or can be implemented into system 10 (shown in FIG. 1).

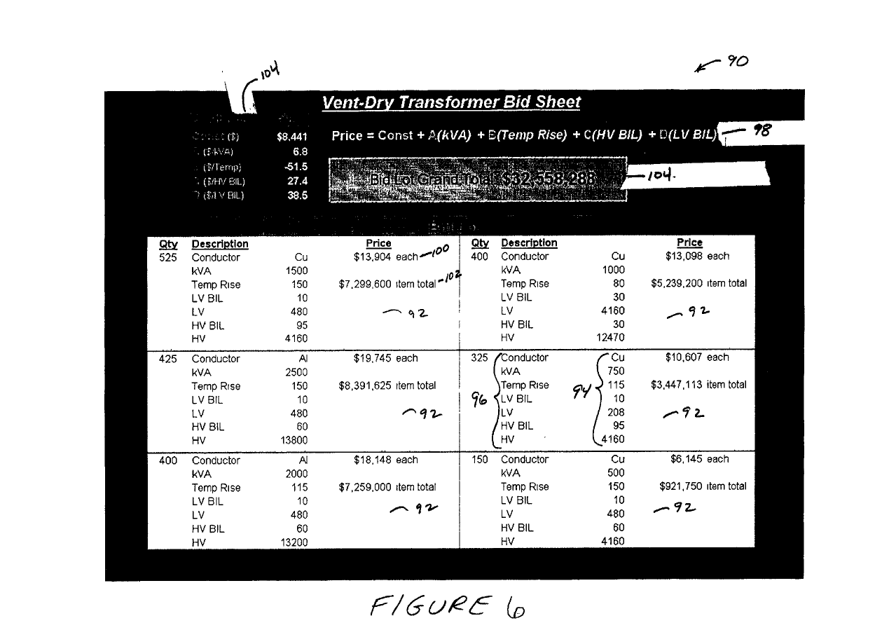

FIG. 6 illustrates an exemplary bid sheet 90, in the form of a user interface stored on server 12 (shown in FIG. 1) and incorporating the final regression equation for pricing described above. In an alternative embodiment, bid sheet 90 is emailed to the supplier and is received via email after bid sheet 90 has been completed. When bid sheet 90 is implemented for reception of bids in a purchase contract, suppliers are not actually quoting prices based on individual costs for products, rather the suppliers are bidding based on items contained on bid sheet 90, which will determine a price when supplying the product. In the transformer example of FIG. 6, bid sheet 90 has been generated utilizing six transformer products 92 including ratings and specifications 94 for parameters 96. The transformers illustrated on bid sheet 90 are not meant to represent actual transformers to be purchased. These specific transformers are displayed to represent data points generated by the pricing equation.

Products 92 are priced according to a final regression equation 98 generated from supplier inputs, as described above. A per unit price 100 and an item total price 102 are displayed. Coefficients 100 of final regression equation 98 are displayed on the user interface and are the subject of actual bids by the suppliers. A total bid 104 for all items desired is also displayed. Total bid 104 is generated by server 12 using the final regression equation for the individual items, multiplying by a quantity of each item to obtain an item total, and adding the item totals to obtain the total bid. In an alternative embodiment, bid sheet 90 is a spread sheet that includes the appropriate equations to generate total bid 104. Bid sheet 90, in one embodiment, is utilized to provide example product pricing to suppliers so they can view the effects of bidding various values. When a new value is entered for the particular items, individual transformer prices are updated, as well as the total package price to reflect the newly calculated equation values.

Using a model to generate pricing accurately represents pricing of a majority of an engineered product line. By using models, electronic auctioning is facilitated, accurate and concise purchase agreements are facilitated, and subsequent pricing of the engineered products is facilitated. By auctioning the pricing model, changes in product price will be explained by the model as will variations from known pricing.

While the invention has been described in terms of various specific embodiments, those skilled in the art will recognize that the invention can be practiced with modification within the spirit and scope of the claims.

1. A method for facilitating the auctioning of a pricing model using a network-based system including a server and at least one device connected to the server via a network, said method comprising the steps of:
receiving product listing and pricing information data from multiple suppliers;
developing an initial regression equation for each supplier based on the received product listing and price information data; and
combining the initial regression equations for each of the suppliers into a final regression equation for a product line.

2. A method in accordance with claim 1 further comprising the step of transmitting to the suppliers the final regression equation along with a list of required products.

3. A method in accordance with claim 1 further comprising the step of receiving purchase contract bids from suppliers.

4. A method in accordance with claim 1 wherein said step of combining the initial regression equations further comprises the step of generating a final regression equation according
COST=847+26.7HYBIL−262LVBIL+16.3kVA+9.02(LVBIL)×(HVBIL) −0.0635(LVBIL)×(HVBIL)²+0.143(TEMP²×kVA²)/1,000,000 −0.0481(TEMP×kVA)−0.000025(TEMP×kVA²)
for an electrical transformer pricing model.

5. A method in accordance with claim 1 wherein said step of receiving product listing and pricing information data from multiple suppliers further comprises the step of providing suppliers a matrix showing desired products to be used in developing the mathematical models.

6. A method in accordance with claim 5 wherein said step of providing suppliers a matrix further comprises the step of providing a spreadsheet of desired products into which at least one of the suppliers can enter pricing information.

7. A method in accordance with claim 2 wherein said step of transmitting to the suppliers the final regression equation comprises the step of transmitting to the suppliers a bid sheet.

8. A system for facilitating the auctioning of purchase contracts for engineered products by implementing pricing models, said system comprising:
at least one device;
a server configured to receive product listing and pricing information data from multiple suppliers, develop an initial regression equation for each supplier utilizing received product listing and price information data, and combine the initial regression equations into a final regression equation for a product line; and
a network connecting said at least one device to said server.

9. A system in accordance with claim 8 wherein said server further configured to post the final regression equation along with required products to enable bids from suppliers.

10. A system according to claim 8 wherein said server further configured to receive purchase contract bids from suppliers.

11. A system according to claim 8 wherein said server further configured to generate a final regression equation according to
COST=847+26.7HVBIL=262LVBIL+16.3kVA+9.02(LVBIL)×(HVBIL) −0.0635(LVBIL)×(HVBIL)²+0.143(TEMP²×kVA²)/1,000,000 −0.0481(TEMP×kVA)−0.000025(TEMP×kVA²)
for an electrical transformer pricing model.

12. A system according to claim 8 wherein said server further configured to provide suppliers a matrix showing desired products to be used in developing the mathematical models.

13. A system according to claim 12 wherein said server further configured to provide a spreadsheet including information regarding a desired product, the spreadsheet configured to receive pricing information entered by the supplier.

14. A system according to claim 9 wherein said server further configured to transmit a bid sheet to the at least one device.

15. A system according to claim 14 wherein said server further configured to accept coefficients into the initial regression equation from a supplier.

16. A system according to claim 8 wherein said network is one of a wide area network, a local area network, an intranet and the Internet.

17. A computer programmed to:
prompt a user to enter product listing and pricing information data from multiple suppliers;
develop an initial regression equation for each supplier based on the received product listing and price information data;
combine the initial regression equations for each of the suppliers into a final regression equation for a product line;
transmit to the suppliers the final regression equation and a list of required products; and
receive purchase contract bids from suppliers.

18. A computer programmed in accordance with claim 17 and further programmed to generate
a final regression equation according to
COST=847+26.7HVBIL−262LVBIL+16.3kVA+9.02(LVBIL)×(HVBIL) −00635(LVBIL)×(HVBIL)²+0.143(TEMP²×kVA² )/1,000,000 −0.0481(TEMP×kVA)−0.000025(TEMP×kVA²)

19. A computer programmed in accordance with claim 17 and further programmed to transmit to suppliers a matrix showing desired products to be used in developing the mathematical models.

20. A computer programmed in accordance with claim 19 and further programmed to transmit to the suppliers a spreadsheet of desired products into which at least one of the suppliers can enter pricing information.

21. A computer programmed in accordance with claim 17 an further programmed to transmit to the suppliers a bid sheet.

22. Apparatus comprising:
means for receiving product listing and pricing information from multiple suppliers;
means for developing an initial regression equation for each supplier based on the received product listing and price information;
means for combining the initial regression equations for each of the suppliers into a combined regression equation for a product line; and
means for receiving purchase contract bids from suppliers.

23. Apparatus in accordance with claim 22 further comprising means for transmitting to the suppliers the combined regression equation and the products to enable bids from the suppliers.

24. Apparatus in accordance with claim 22 further comprising:
means for providing suppliers a matrix illustrating desired products to be used in developing mathematical models; and
means for providing a spreadsheet of desired products into which a supplier can enter pricing information.
